(19) United States
(12) Patent Application Publication
(10) Pub. No.: US 2025/0323745 A1
(43) Pub. Date: Oct. 16, 2025

(54) CELL DORMANCY IN STANDALONE SINGLE CARRIER FREQUENCY DOMAIN EQUALIZATION (SC-FDE)-BASED SYSTEMS

(71) Applicant: InterDigital Patent Holdings, Inc., Wilmington, DE (US)

(72) Inventors: Patrick SVEDMAN, Stockholm (SE); Tariq ELKOURDI, Belleville, NJ (US); Ravikumar PRAGADA, Warrington, PA (US)

(21) Appl. No.: 18/633,835

(22) Filed: Apr. 12, 2024

(51) Int. Cl. H04J 11/00; H04W 74/08; H04W 74/0833

(52) U.S. Cl. CPC H04J 11/0073; H04W 74/0833; H04W 74/0866

(57) ABSTRACT

Procedures, methods, architectures, apparatuses, systems, devices, and computer program products related to cell dormancy in standalone single carrier frequency domain equalization (SC-FDE)-based systems. One method may include determining a set of candidate primary synchronization signal (PSS) parameter values, and performing, based on the set of candidate PSS parameter values, PSS detection on a synchronization frequency. Based on the PSS detection, the method may include determining at least one PSS having corresponding PSS parameter values from the set of candidate PSS parameter values and, based on the PSS parameter values of one or more of the at least one PSS, determining that a cell is in a dormancy state. The method may include determining to transmit a cell activation request (CAR) based on one or more criteria associated with the at least one PSS, determining a CAR resource based on the at least one PSS, and transmitting the CAR on the CAR resource.

### FIELD

Example embodiments described in the present disclosure are generally directed to the fields of communications, software and encoding, including, for example, to methods, architectures, apparatuses, systems related to cell dormancy in standalone single carrier frequency domain equalization (SC-FDE)-based systems.

### BACKGROUND

In 5G NR, when a device (e.g., WTRU or UE) starts initial access or decides to transition from idle/inactive state to connected state, it searches for synchronization signal/physical broadcast channel (SS/PBCH) blocks (SSBs) which are periodically transmitted by the network. An SS/PBCH block consists of a Primary Synchronization Signal (PSS), a Secondary Synchronization Signal (SSS) and Physical Broadcast Channel (PBCH). It occupies four orthogonal frequency division multiplex (OFDM) symbols in the time domain and 240 subcarriers in the frequency domain.

### SUMMARY

An embodiment may include a method that may be implemented by a WTRU. The method may include determining a set of candidate primary synchronization signal (PSS) parameter values and performing, based on the set of candidate PSS parameter values, PSS detection on one or more synchronization frequencies. Based on detecting one or more PSS, the method may include determining at least one PSS having corresponding PSS parameter values from the set of candidate PSS parameter values. Based on the PSS parameter values of one or more of the at least one determined PSS, the method may include determining that a cell is in a dormancy state. The method may then include determining a cell activation request (CAR) resource based on the at least one determined PSS, and transmitting, based on one or more criteria associated with the at least one determined PSS, the cell activation request (CAR) on the determined CAR resource.

An embodiment may be directed to a WTRU comprising circuitry, such as a processor, memory, transmitter and/or receiver. The circuitry may be configured to determine a set of candidate primary synchronization signal (PSS) parameter values and perform, based on the set of candidate PSS parameter values, PSS detection on one or more synchronization frequencies. Based on detecting one or more PSS, the circuitry may be configured to determine at least one PSS having corresponding PSS parameter values from the set of candidate PSS parameter values. Based on the PSS parameter values of one or more of the at least one determined PSS, the circuitry may be configured to determine that a cell is in a dormancy state. The circuitry may then be configured to determine a cell activation request (CAR) resource based on the at least one determined PSS, and transmit, based on one or more criteria associated with the at least one determined PSS, the cell activation request (CAR) on the determined CAR resource.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates SSB-CORESET multiplexing patterns in NR;

FIG. 3 illustrates an example SC-FDE block;

FIG. 4 illustrates an example SC-FDE transmtter and receiver;

FIG. 5 illustrates a block diagram of a SC-FDE;

FIG. 6 illustrates an example of a CAR resource;

FIG. 7 illustrates another example of a CAR resource;

FIG. 8 illustrates an example SC-FDE Flexible SS BW/sequence length;

FIG. 9 illustrates PSS transmission in a PSS burst and SSS/PBCH transmission in an SSS/burst;

FIG. 10 illustrates a flow diagram of a method, according to an embodiment;

FIG. 11 illustrates a flow diagram of a method, according to an embodiment;

FIG. 12 illustrates a flow diagram of a method, according to an embodiment;

FIG. 13 illustrates another example of a CAR resource;

FIG. 14 illustrates another example of a CAR resource;

FIG. 15 illustrates another example of a CAR resource;

FIG. 16 illustrates an example of time-locations for monitoring of non-dormant PSS corresponding to transmitted CARs; and

FIG. 17 illustrates an example flow diagram of a method, according to some example embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

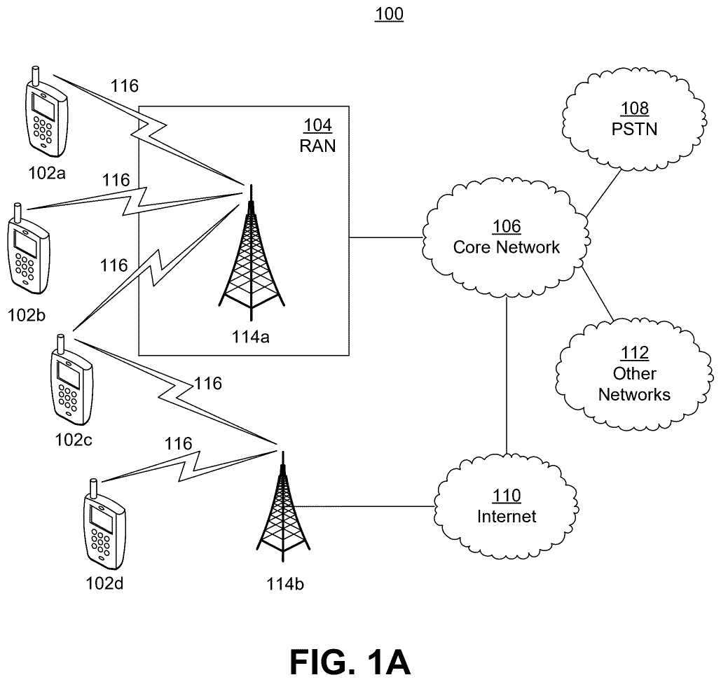

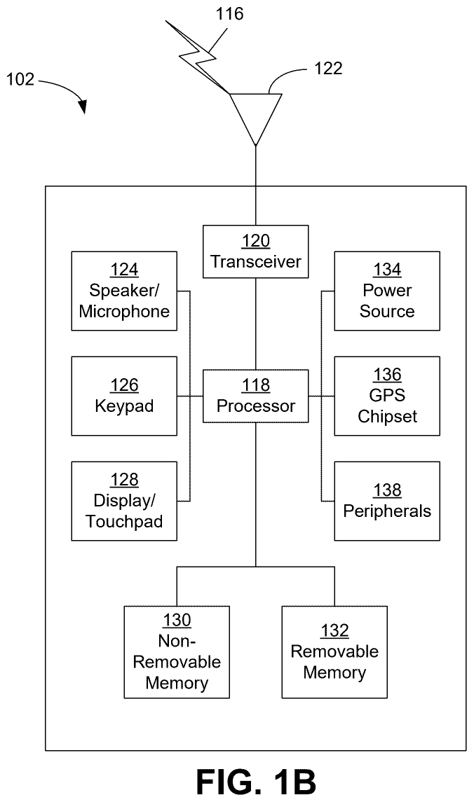

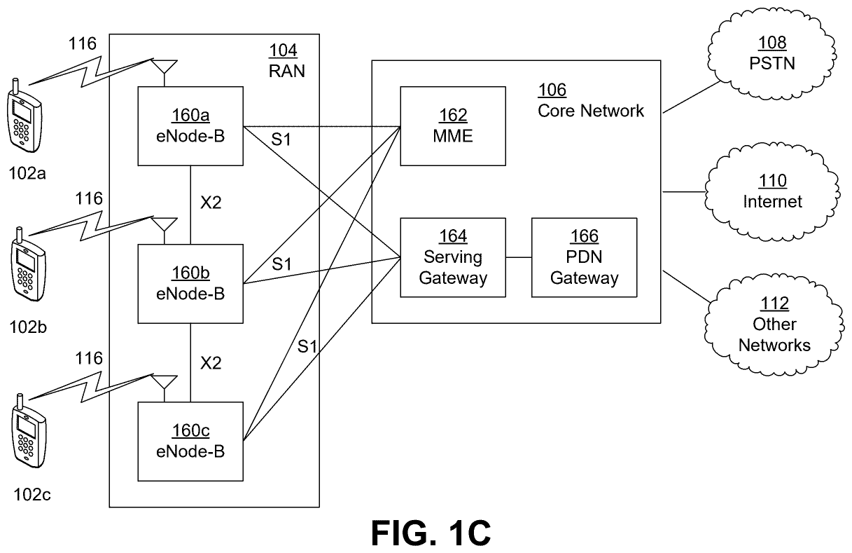

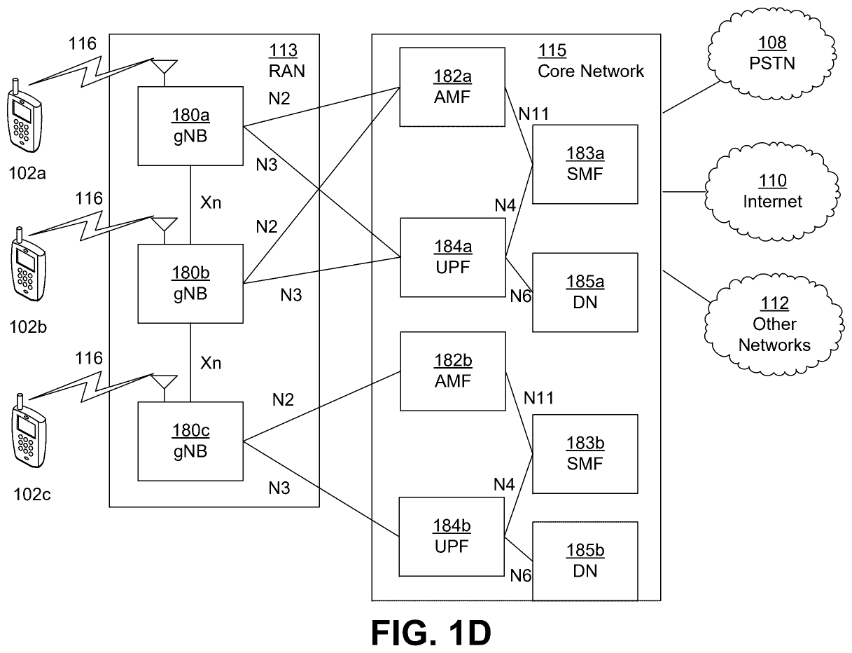

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHZ, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments disclosed herein are representative and do not limit the applicability of the apparatus, procedures, functions and/or methods to any particular wireless technology, any particular communication technology and/or other technologies. The term network in this disclosure may generally refer to one or more base stations or gNBs or other network entity which in turn may be associated with one or more Transmission/Reception Points (TRPs), or to any other node in the radio access network.

It is noted that, throughout example embodiments described herein, the terms “base station”, “seving base station”, “RAN,” “RAN node,” “Access Network,” “NG-RAN,” “gNodeB,” and/or “gNB” may be used interchangeably to designate any network element such as, e.g., a network element acting as a serving base station. It should be understood that embodiments described herein are not limited to gNBs and are applicable to any other types of base stations.

In 5G NR, when a device (e.g., WTRU or UE) starts initial access or decides to transition from idle/inactive state to connected state, it searches for synchronization signal/physical broadcast channel (SS/PBCH) blocks (SSBs) which are periodically transmitted by the network. An SS/PBCH block consists of a Primary Synchronization Signal (PSS), a Secondary Synchronization Signal (SSS) and Physical Broadcast Channel (PBCH). It occupies four orthogonal frequency division multiplex (OFDM) symbols in the time domain and 240 subcarriers in the frequency domain. The SSBs in a cell are transmitted in a time-multiplexed pattern, e.g., by transmitting different SSBs on different beams in a beam sweeping fashion. The time-multiplexed set of SSBs is sometimes referred to as an SS burst set. The SSBs in the time-multiplexed set are periodically transmitted, with a periodicity of, for example, 5, 20, or 80 ms. The maximum number of time multiplexed SSBs within an SS burst set can be up to four for frequencies below 3 GHZ, or eight for frequencies between 3 GHz and 7 GHz or 64 for frequencies above 7 GHZ (FR2). Time domain location of SSB is different for different SSB numerologies. Each SSB carries an SSB index to indicate the relative location of the SSB to the half frame boundary. The network may transmit only a subset of all supported SSBs. The device can be informed of which SSBs are transmitted via a RRC Information Element (IE) called “ssb-PositionInBurst”.

In NR, there are 3 possible PSS sequences (same as in LTE). NR PSS is generated by using a binary phase shift keying (BPSK) modulated m-sequence of length 127. M-sequence is used to address time/frequency offset ambiguity problem encountered in Zadoff-Chu sequence used in LTE. PSS is used for coarse time/frequency synchronization. PSS is also one of the factors determining Physical Cell ID. A UE implementation may run parallel and/or sequential correlators to detect one of the 3 possible PSS sequences, with different time and frequency offsets. If a peak is detected at a particular time/frequency, the UE may assume which PSS that is transmitted and an SSB time/frequency offset.

There are 336 possible SSS sequences in NR. After detecting PSS, at least the coarse timing and frequency of SSS is known, given that the UE may assume that PSS and SSS are transmitted on the same antenna port. If an SSS is detected, a physical cell ID (PCI) can be calculated. The PCI is needed to demodulate PBCH. Using PCI, the UE can determine the frequency-domain position of demodulation reference signals (DM-RS) in PBCH.

The SSB index may be provided to the UE as two parts: an implicit part encoded in the PBCH DMRS and in the scrambling applied to the PBCH and an explicit part included in the PBCH payload. The PBCH depends on the SSB block index. The UE may detect which of the (e.g., 4 or 8) possible versions of DMRS sequences that is used to determine which one was sent for a particular SSB received. The UE may decode PBCH to obtain a Master Information Block (MIB). MIB may carry 3 bits for SSB index which the UE uses, along with knowledge of which DMRS sequence was transmitted, to determine up to 64 SSB indexes, in case of up 64 SSBs. MIB also contains parameters required to receive SIB1 (carried on DL-SCH) which is needed for Random access process. Once SIB is decoded, the UE has information required for RACH.

The following are some example use cases of a synchronization signal: acquisition and cell search (e.g., acquisition of frequency and symbol synchronization to a cell, acquisition of frame timing of the cell—that is, determine the start of the downlink frame), determination of the physical-layer cell identity (PCI) of the cell, acquisition and demodulation of system information channels and associated DMRSs (PBCH, PDSCH for system information and associated DRMSs), acquisition and demodulation of paging information (PDSCH for paging and associated DRMRs), RRM measurements in support of L3 mobility, cell search in idle mode and cell re-selection, handover in RRC connected mode, and RLM procedures, and beam management measurements (i.e., PHY measurements) in support of beam management procedures, including QCL and TCI framework.

An acceptable cell is a cell on which a UE may camp in idle/inactive mode to obtain limited service, e.g., originate emergency calls, receive notifications from Earthquake and Tsunami Warning System (ETWS) or Commercial Mobile Alert System (CMAS), etc. An acceptable cell fulfils a minimum set of requirements, such as not being barred, and a cell selection criterion. The cell selection criterion requires that the cell received power and cell quality are high enough.

A suitable cell is a cell on which a UE may camp in idle/inactive mode for normal service such as receive system information, tracking area information, registration area information, paging and notification messages, etc., from the network, as well as initiate transfer to connected mode. A suitable cell fulfils the set of requirements for an acceptable cell, as well as additional requirements, such as that the cell is a part of a mobile network that is selected or registered by the UE.

Upon SSB and MIB reception, a NR UE may monitor a common control resource set (CORESET), CORESET #0, for Type0-PDCCH CSS set (search space #0). FIG. 2 illustrates SSB-CORESET multiplexing patterns 1-3 in 5G NR. There are three different SSB-CORESET multiplexing patterns defined, as illustrated in FIG. 2. In pattern 1, the associated SSB and CORESET are time-multiplexed, e.g., in a different subframes or frames. In pattern, 2, the associated SSB and CORESET are in the same slot, but not the same symbol. In pattern 3, the CORESET is frequency multiplexed with the associated SSB.

The MIB includes a 4-bit configuration index for CORESET #0 and a 4-bit configuration index for search space #0. In 5G NR, the UE determines the SSB-CORESET multiplexing pattern based on: the 4-bit configuration index for CORESET #0, the SSB subcarrier spacing (SCS), and the PDCCH subcarrier spacing. For example, if the 4-bit configuration index=5, the UE determines the following multiplexing patterns:
SSB-CORESET multiplexing pattern 1 if SSB SCS=30 kHz and PDCCH SCS=30 kHz
SSB-CORESET multiplexing pattern 2 if SSB SCS=240 kHz and PDCCH SCS=120 kHz
SSB-CORESET multiplexing pattern 3 if SSB SCS=120 kHz and PDCCH SCS=120 kHz

In other words, the UE cannot always determine the SSB-CORESET multiplexing pattern only based on the MIB content. The UE determines the PDCCH subcarrier spacing based on the frequency range and a 1-bit parameter in the MIB.

Single carrier with frequency domain equalization (SC-FDE) uses a single carrier waveform that, compared to OFDM, exhibits improved Peak to Average Power Ratio (PAPR) characteristics, robustness to phase noise and low-resolution Analog-to-Digital Conversion (ADC)/Digital-to-Analog Conversion (DAC). Although both OFDM and SC-FDE use a single Discrete Fourier Transform (DFT) block and a single inverse DFT (IDFT) block (same overall complexity), the SC-FDE IDFT operation happens at the receiver. The higher power efficiency of the SC-FDE transmitter can translate into an increase in cell coverage area. Due to its single carrier nature, SC-FDE does not provide means for frequency multiplexing (within an SC-FDE carrier) although other multiplexing means (time, space, polarization, etc.) are still applicable.

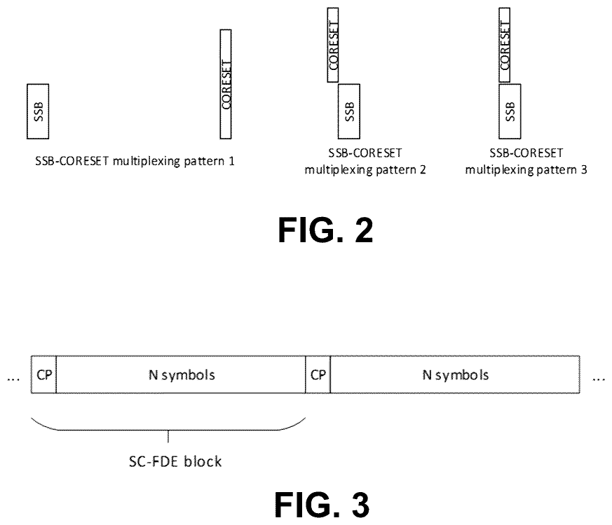

To enable frequency domain equalization using DFT/IDFT, similar to OFDM, SC-FDE systems may typically use a cyclic prefix (CP) with a duration that is longer than the channel. FIG. 3 illustrates an example of a SC-FDE block. As illustrated in the example of FIG. 3, N symbols plus a CP forms an SC-FDE block.

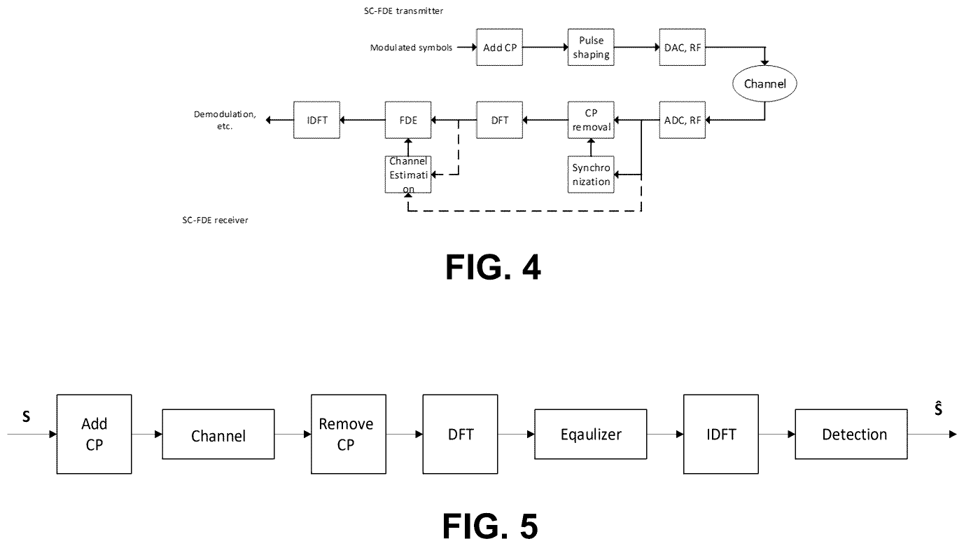

In OFDM, demodulation and detection are performed in the frequency domain. In SC-FDE, demodulation and detection are performed in the time domain, after FDE. FIG. 4 illustrates an example SC-FDE transmitter and receiver. The DFT and IDFT size should preferably match the number of symbols in the SC-FDE block (N in FIG. 3).

As illustrated in FIG. 5, at the SC-FDE transmitter, groups of Log₂M data bits are mapped into complex symbols in an M-ary complex constellation. Then, N symbols are grouped into blocks and sent to the encoder. A cyclic prefix (CP) is added to each block, by prefixing a copy of its last N_{CP} symbols. This prevents Inter-block interference (IBI) but wastes bandwidth and is energy inefficient. It introduces short term periodicity which makes the linear convolution of the channel impulse response look like a circular convolution. Circular convolution in the time domain is useful as it translates into multiplication in the frequency domain. The CP extended blocks are fed to a parallel to serial converter, a digital to analog convertor, frequency up-convertor and a filter before it gets transmitted over the wireless channel. At the receiver, the signal is fed to a frequency down-converter, a filter and analog to digital converter. The output sequence of samples is grouped into blocks again. For each block, CP is discarded, and the remaining samples are sent to an DFT block for conversion to frequency domain. Then, a frequency domain equalizer (FDE) is used to compensate for channel distortion. The output symbols are fed to an IDFT block for conversion to the time domain.

The SC-FDE transmitted signal bandwidth is proportional to the symbol rate. The SC-FDE block duration depends on symbol rate, assumed receiver DFT/IDFT size, and CP. The SC-FDE block duration may be given by Equation 1 below:

$$block duration = \frac{DFT size}{symbol rate} + CP duration$$

The CP duration should accommodate communication channel time dispersion, time synchronization errors, etc. It consists of an integer number of symbols that is less than the assumed receiver DFT/IDFT size. For a fixed CP duration (in seconds) and DFT/IDFT size, CP overhead grows with symbol rate, i.e., with shorter SC-FDE block duration.

As described above, DL transmission based on SC-FDE waveform has various benefits compared to CP-OFDM waveform. An important part in communication systems is the design of DL synchronization signals with consideration to impacts on UE and network power consumption, synchronization performance, and resource overhead in support of initial access procedures (e.g., cell acquisition, system information reception), etc. A general problem context herein is a synchronization framework for SC-FDE DL transmission and reception considering these aspects.

Network energy savings is an increasingly important topic. One aspect of network energy consumption is the minimum network energy consumption level that can be achieved during low-traffic hours, e.g., during nighttime when there are no connected UEs in the SC-FDE cell(s).

One way to reduce the minimum network energy consumption is to turn off the cell(s). While this results in very low, potentially zero, power consumption, it prohibits access to the network.

Thus, some example embodiments described herein address at least the problem of how network energy consumption can be minimized when there are no connected UEs in the SC-FDE based cell(s), while still allowing idle UEs to access the network, if needed.

It is noted that, as used herein, the term “cell” may also refer to “network,” “carrier” “base station,” “TRP,” etc.

Certain example embodiments may relate to standalone access to a dormant cell. According to some embodiments, the minimum (non-zero) cell signal transmission in the SC-FDE based synchronization framework is the PSS, which is transmitted in the PSS burst. A legacy UE that detects a PSS but cannot receive/decode SSS/PBCH could not access the cell. In this embodiment, PSS-based determination of cell dormancy is provided, e.g., based on the PSS sequence. According to this embodiment, upon detection of cell dormancy, the UE determines to transmit a cell activation request, e.g., if the detected non-dormant cells are not suitable. If so, the UE may determine a resource for transmission of cell activation request. The resource may come (e.g., may be available or scheduled) a certain time offset after the detected PSS, where the UE may determine the time offset based on PSS parameter(s), e.g., PSS symbol rate and PSS periodicity. The resource may be divided into M parts, where each part is located the time offset after a PSS. This allows the network to perform request detection after (e.g., only after) every M^{th} PSS. Finally, the UE transmits the cell activation request on the determined resource.

Some example embodiments may include or be directed to a UE procedure for standalone access to a dormant cell. In an embodiment, a UE may be configured to determine one or more set(s) of candidate PSS parameter values for one or more corresponding PSS parameter(s) associated with one or more synchronization frequencies. For example, the PSS parameter(s) may include one or more of PSS sequence index, PSS sequence initialization value, PSS sequence length, PSS repetition factor, PSS periodicity, PSS symbol rate, etc.

In an embodiment, the UE may be configured to perform PSS detection on the one or more synchronization frequencies based on the set(s) of candidate PSS parameter values. According to an embodiment, the UE may detect one or more PSS with corresponding one or more detected PSS parameter value(s) from the one or more corresponding set(s) of candidate PSS parameter values. For example, the UE might detect a PSS with a PSS sequence index from a set of candidate PSS sequence indices and/or a PSS symbol rate from a set of candidate PSS symbol rates.

In an embodiment, based on the one or more detected PSS parameter value(s), the UE may be configured to determine whether (or that) a cell is in a dormancy state. For example, the UE may determine that a cell is in a dormancy state if any one or more of a sequence index, length, and/or repetition factor of a detected PSS belongs to a subset of the set of candidate PSS sequence indices/lengths/repetition factors that corresponds to cell dormancy. For instance, in some cases, the UE may detect both PSS corresponding to a dormancy state and PSS corresponding to a non-dormancy state on the same or different synchronization frequencies.

In an embodiment, if the UE determined that a cell is in a cell dormancy state, the UE may determine to transmit a cell activation request (CAR) based on one or more criteria that may be based on the detected one or more PSS. For example, the one or more criteria may include (or may be based on) any one or more of: (i) the received power of a PSS corresponding to dormancy is above a threshold; (ii) the maximum received power among the PSS(s) corresponding to non-dormancy is below a threshold; (iii) the difference between (a) the received power of a PSS corresponding to dormancy and (b) the maximum received power among the PSS(s) corresponding to non-dormancy, is above a threshold; and/or (iv) one or more (e.g., all detected) non-dormant cell(s) (with non-dormant PSS) are not suitable, e.g., they are barred or have received power or quality below a threshold.

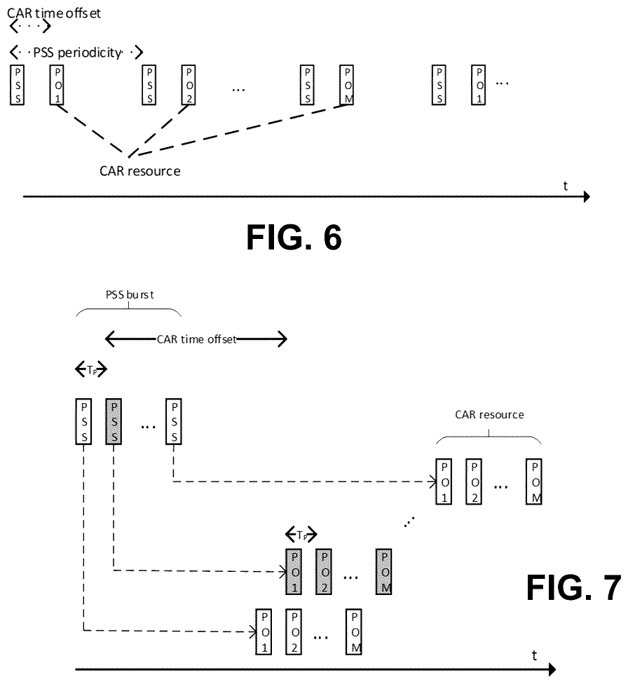

In an embodiment, if the UE determined to transmit CAR, the UE determines a CAR resource based on a detected PSS corresponding to dormancy. For example, the UE may determine a time offset based on one or more detected PSS parameter value(s), e.g., the PSS symbol rate and/or the PSS periodicity. The UE may determine the resource as a time-frequency resource that starts the determined time offset after the detected PSS. For example, the UE may determine a resource that comprises multiple time-frequency resources that are separated in time by the periodicity of the detected PSS. FIG. 6 illustrates an example of a CAR resource comprising M PRACH occasions (PO). In an example, the UE may first determine an intra-burst PSS separation, e.g., based on the PSS symbol rate. The UE may then determine a resource that comprises multiple time-frequency resources that are separated in time by the intra-burst PSS separation. FIG. 7 illustrates an example of a CAR resource comprising M PRACH occasions (PO) separated by PSS separation.

In an embodiment, the UE may transmit a CAR on the determined resource for CAR. According to an embodiment, if the UE determined not to transmit a CAR, e.g., since a detected PSS is not in a dormancy state, the UE may receive system information and performs random access accordingly.

In various embodiments described herein, a UE compares with a threshold. The thresholds may be different, or some thresholds may be the same. A threshold may, for instance, be defined in a specification and may be specific for a synchronization frequency, frequency band, frequency range, etc. Alternatively, the UE may have previously received a configuration of a threshold in a system information or during a previous connection to the network. In yet another alternative, a threshold may be pre-configured in the UE. In yet another alternative, a threshold may be selected by the UE.

A synchronization signal may be transmitted on a certain frequency, e.g., the center frequency of the signal, and a certain signal bandwidth. In order to limit the number of center frequency candidates/hypotheses, a UE may assume that a synchronization signal is transmitted on a frequency that belongs to a synchronization raster. A synchronization raster may be a set of frequency points, e.g., corresponding to center frequencies, that may be defined in a specification or configured to a UE.

A synchronization raster may comprise a set of frequency points for a frequency band that are uniformly or non-uniformly spaced (separated) within the band. The frequency spacing may be the same in different bands, e.g., adjacent bands, or different. A UE may determine a set of synchronization raster points by using an equation, where the parameters in the equation may be defined in a specification or configured. Alternatively, the UE may determine a set of synchronization raster points from a table, that may be defined in a specification or configured to the UE.

In some cases, a synchronization signal may be transmitted with a center frequency that is offset from a synchronization raster frequency, where the offset may be configurable and/or belong a predefined set of offsets (e.g., 1, 2, 3, or 4 offsets, potentially including offset 0).

The synchronization raster and synchronization raster point concepts may be utilized in some embodiments described herein. However, these terms could also be understood to represent, more generally, a particular carrier frequency, which does not necessarily lie on a synchronization raster, for example, as represented by an Absolute Radio-Frequency Channel Number (ARFCN).

The term synchronization frequency is used herein to represent a frequency, e.g., carrier frequency, on which a UE performs cell search, synchronization signal detection, synchronization signal based measurements, and/or synchronization, etc. A synchronization frequency may correspond to a synchronization raster point, an ARFCN, etc., for example as discussed above.

It is noted that a UE performing an operation on a synchronization frequency may include the UE performing an operation on the synchronization frequency plus/minus a frequency offset that is typically small in relation to the synchronization frequency. A synchronization signal may be received slightly off the synchronization frequency due to Doppler shifts, imperfect oscillators, etc.

For PSS reception, etc., a UE may assume the following in various combinations. One or more PSS sequences may be defined. In some cases, the different PSS sequences may be based on different cyclic shifts of a single sequence. The different PSS sequences may be associated with different parameter values, e.g., different index values. In some cases, the parameter value may be directly used to determine the cyclic shift.

In some cases, the different PSS sequences may be generated using different initialization values, e.g., for a shift register or a pseudo-random sequence generator.

The modulated symbols may be pulse shaped using a pulse or a filter, which may be associated with one or more parameters, such as a roll off factor. The roll off factor may have a value between 0 and 1, where small roll off factor may correspond to steeper roll off in the pulse frequency response, while resulting in higher peak-to-average-power ratio (PAPR), corresponding to a stricter roll-off. A larger roll off factor, on the other hand, would correspond to more relaxed roll-off and lower PAPR. Example pulses include raised cosine, such as the root raised cosine (RRC). In some cases, the UE may use a matched filter in its receiver, where the filter may be matched to the pulse/filter at the transmitter, e.g., an RRC filter.

The block of PSS symbols may be prepended or appended with a CP, a unique word (a predefined sequence of symbols), or zeros. In some cases, PSS symbols are not prepended or appended in such a way. Herein, the term CP may be used to denote a prepended or appended CP, unique word, zeros, or similar.

In some cases, a PSS may comprise multiple consecutive or non-consecutive repetitions of a PSS sequence.

The baseband symbols, including CP, if any, are up converted and transmitted on the PSS frequency, e.g., on a synchronization raster point. The PSS symbols are transmitted at a symbol rate, e.g., at a certain number of symbols per second. The bandwidth occupied by the PSS, e.g., the x dB bandwidth (x is for instance 3, 6, etc.), may depend on multiple factors, such as the PSS symbol rate and the used roll off factor.

The notion of different PSSs (or PSSs, multiple PSSs, etc.) may refer to PSSs, e.g., PSS detection peaks, with any combination of different PSS sequences, different PSS synchronization frequencies, different PSS time offsets, different PSS frequency offsets, and/or different UE Rx beams/panels/antennas used to receive the PSSs. Similarly, the term a PSS may refer to a PSS, e.g., PSS detection peak, with such properties.

The UE may determine that PSS detection peaks that are separated by a PSS periodicity correspond to the same PSS, e.g., if the peaks correspond to the same PSS sequence, synchronization frequency, frequency offset, and/or UE Rx beam/panel/antenna, etc.

It is noted that the term SSS/PBCH may be used herein, and it may refer to SSS and/or PBCH.

In SC-FDE systems, a UE receives the following synchronization signals (SS) in order to perform cell search: the primary synchronization signal (PSS) and secondary synchronization signal (SSS) which may comprise of a first SSS sequences (SSS1) and a second SSS sequences (SSS2). Unlike in NR, the reception of these signals does not necessarily have to be in consecutive time domain resources. Also, unlike NR, the SS/PBCH blocks do not necessarily have to be confined in a half-frame duration but more flexibly in a 2⁻ⁿ, n={1, 2, . . . } frame portion. For a frame portion with SS/PBCH blocks, the first block index of candidate PSS/SSS/PBCH blocks are determined according to the symbol rate of the blocks as follows, where index 0 corresponds to the first block of the first slot in the frame portion.

Case A, B, . . . , etc.: Symbol Rate 1, 2, . . . etc.: the first block of the candidate SS/PBCH blocks have indexes of {a₁, a₂, . . . aₘ}+14n.

Each case may have a number of sub-patterns (e.g., Case A1, Case A2, etc.), one sub-pattern per SC-FDE frequency band. Two cases or more might have the same SS/PBCH pattern despite the different symbol rate. If the symbol rate of SS/PBCH is unknown, the UE determines the pattern case based on pre-defined cases in a specification.

5G NR signals such as SSB and TRS are based on CP-OFDM. Details specific to OFDM such as sub-carrier spacing, FDM of SSS and PBCH as well as DMRS for demodulating PBCH cannot be directly translated to SC-FDE since it is a pure single carrier waveform. Therefore, a new synchronization signal design/framework is required. Some aspects to consider when designing a synchronization signal is its impact on UE power consumption (due to electronic components such as ADCs). A synchronization signal bandwidth needs to take both minimum channel bandwidths and different UE capabilities into account. Moreover, different synchronization signal bandwidths may give different synchronization accuracy. For example, and NR SSB may provide coarse time synchronization and an NR TRS may provide fine time synchronization. Moreover, even within an SSB signal, PSS may provide the coarse time synchronization, while SSS may provide a finer time synchronization.

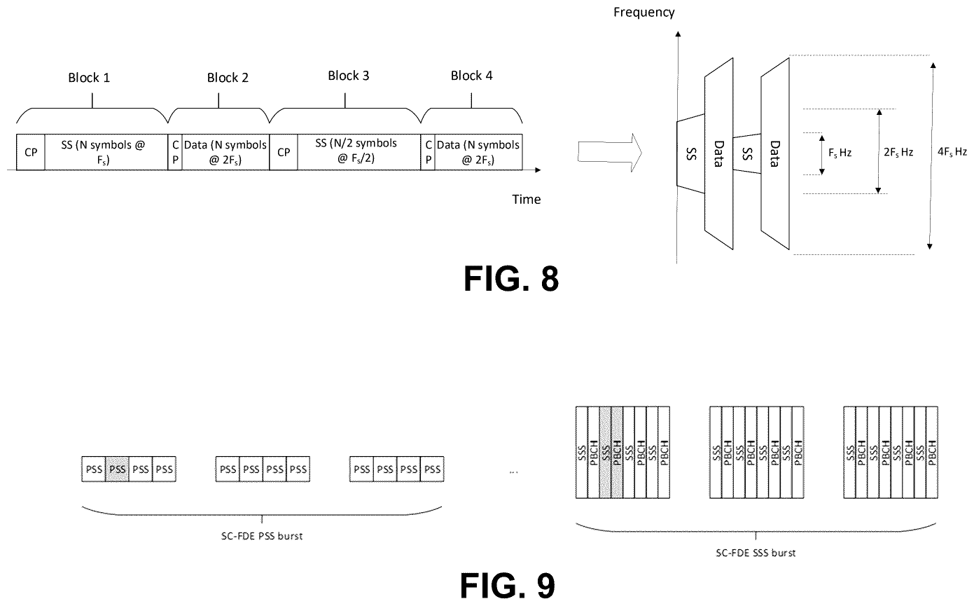

To achieve high spectrum utilization, the bandwidth of data transmissions/the data symbol rate needs to be highly flexible, i.e., configurable with a fine granularity. FIG. 8 shows an example of an SC-FDE SS with flexible bandwidth and sequence length. The SC-FDE block is comprised of a cyclic prefix of P symbols, and data of N symbols as shown in block 1. The symbols are transmitted at a rate Fₛ symbols per second and, therefore, the block duration is P+N/Fₛ. In the frequency domain, the SS signal bandwidth is approximately equal to 2Fₛ, where the factor 2 comes from the pulse shaping filter parameters (e.g., RRC roll off factor). Here, N data symbols may be transmitted in block 2 with half the block duration of block 1 and double the symbol rate, which means that the data signal will occupy double the BW of block 1. Note that doubling the BW typically means doubling the receiver sampling rate. It is also noted that, the transmitter and receiver symbol rate (BW) should be aligned. This is a clear difference from the current NR CP-OFDM based design, in which the SCS should be aligned. Block 3 has N/2 symbols and is transmitted over the same time duration as block 1 but with half the symbol rate.

The synchronization raster is typically sparse to allow for faster initial access time and less cell search effort (i.e., fewer hypothesis to test). Still, for a synchronization raster point, a significant UE effort may be needed for PSS-based cell search.

Firstly, before PSS detection, the frame timings of the cells on the raster point are unknown. Furthermore, it is still unknown to the UE which SSBs from which cells that are detectable. Hence, the UE may need to receive samples from at least a whole SSB period, which the UE may assume is 20 ms, and search for PSSs in all those samples, which is associated with a considerable UE effort.

Secondly, the frequency offset, e.g., due to Doppler shift, for detectable PSS(s) transmitted by a TRP are unknown. The UE may move at high speed towards a first TRP, at high speed towards a second TRP, and with zero relative speed towards a third TRP. Hence, the UE may need to perform PSS detection (in all the received samples) for various PSS frequency offset hypotheses, which further contributes to the UE effort associated with PSS search at a synchronization raster point.

The UE uses different algorithms of frequency and time offset estimation and/or correction for which the details were not specified in 3GPP standards. The two most prominent algorithms depend on cross-correlation and auto-correlation methods. In the cross-correlation algorithms using PSS, the received signal is correlated with known patterns stored at the UE. This algorithm is more efficient for small frequency offset values (i.e., Fractional Frequency Offset (FFO)). The auto-correlation algorithm using CP auto-correlates the received signal with the corresponding CP part. The accuracy of this method can be improved by averaging the estimate of the frequency/time offsets over many OFDM symbols. For a large carrier frequency offset (CFO), the Fractional Frequency Offset (FFO) is estimated using the auto correlation method and the Integer Frequency Offset (IFO) is obtained by evaluating the shift of the received PSS. After the detection of the first PSS, subsequent PSSs are transmitted periodically within each SSB transmission.

In NR, since SSS occupies the third OFDM symbol of the SSB block, the UE is able to identify SSS timing right after the detection of the first PSS. Periodic SSS transmissions are aligned with SSB timing (i.e., occur with the same periodicity). The UE uses the same frequency filter for PSS and SSS since both occupy the same frequency resources. Every 336 SSS sequences are associated with 1 of the 3 PSS sequences which yields a total of 1008 possible PCIs. The UE derives PCI group number

$${N}_{ID}^{( 1 )}$$

from SSS and the Physical Layer identity

$${N}_{ID}^{( 2 )}$$

from PSS according to:

$${N}_{ID}^{Cell} = 3 {N}_{ID}^{( 1 )} + {N}_{ID}^{( 2 )}$$

$$where {N}_{ID}^{( 1 )} ∈ \{ 0 , 1 , … , 335 \} and {N}_{ID}^{( 2 )} ∈ \{ 0 , 1 , 2 \} .$$

In general, the timing and frequency offset of SSS may be largely known upon the detection of the corresponding PSS. Therefore, the UE effort for SSS detection, e.g., in terms of the number of samples the UE needs to process, is significantly less than the UE effort for PSS detection.

The use of “Narrowband” PSS and a limited number of candidate PSS symbol rates have benefits. As discussed above, the UE effort for PSS detection is high, due to the high degree of uncertainty in the time/frequency offsets of detectable PSSs, resulting in many candidates/hypotheses. Hence, the introduction of a large number of additional candidate PSS, e.g., in terms of PSS symbol rate, might not be feasible. A single, or a low number of, candidate PSS symbol rates per synchronization raster point would be preferable from a UE complexity and power consumption perspective.

In case of multiple candidate PSS symbol rates, the network may select to use a lower PSS symbol rate (and bandwidth) if the total PSS beam sweeping time is reasonable, e.g., if the number of PSS beams is moderate. If the number of PSS beams is very high, the network may select a higher PSS symbol rate (and bandwidth) keep down the PSS overhead.

If a single PSS symbol rate (and corresponding PSS bandwidth) needs to be specified for a raster point, it needs to fit within the channel and carrier bandwidth in all relevant scenarios. With narrowband PSS, the UE power efficiency is increased as the UE receiver in a narrowband configuration uses less power in the ADC. Moreover, the noise power will be less due to lower receiver BW which increases PSS SNR. Consequently, a relatively narrow PSS bandwidth may be suitable.

The use of wideband SSS bandwidth and PSS/SS separation in time have benefits. In 5G NR, SSS/PBCH is repeated in the time domain, e.g., in predefined directions (or beams). This beam “sweeping” process happens in what is known as a burst and is repeated periodically. The maximum number of beams is frequency dependent and typically increases with frequency. Wideband SSS/PBCH has the benefit of requiring less time for sweeping a certain number of beams, resulting in less resource overhead, considering the lack of frequency multiplexing in an SC-FDE system. Furthermore, an “SSS burst” that is compact in time results in shorter UE measurement windows for inter-frequency measurement, resulting in higher efficiency.

In 5G NR, the SSB typically does not provide sufficient synchronization accuracy for the highest level of spectral efficiency, e.g., high order modulation, since it's not wideband enough. Therefore, a wideband CSI-RS for tracking (TRS) needs to be transmitted in every cell with connected UEs, resulting in additional resource overhead, power consumption, etc. A wideband SSS could, to a greater extent, be used also for fine synchronization, reducing the need for an additional TRS.

With different PSS and SSS symbol rates (and bandwidths), it may be beneficial to separate PSS and SSS in time, e.g., in order to reduce the amount of symbol rate switching compared to the case with interleaved PSSs and SSSs. Instead, a number of PSS may be transmitted/received consecutively in a cell. Another benefit of separating PSS and SSS in time may be that the burst of PSS, as well as the burst of SSS, may be more compact that a burst of combined PSS+SSS. This may provide shorter measurement time for UEs that are interested in only PSS-based or only SSS-based measurement.

Different PSS and SS center frequencies have benefits. In 5G NR, PSS and SSS share the same center frequency. In order to reduce the PSS-based cell search effort during initial access, the SSB center frequency is constrained to the sparse synchronization raster points. The synchronization raster points are typically not at the center frequency of the channel or carrier. In OFDM and NR, this is not a problem since the SSB may be located off the center of the channel and/or carrier. A UE that receives the whole DL carrier can still receive the off-center SSB due to the inherent FDM nature of OFDM.

A sparse synchronization raster for PSS is equally beneficial in an SC-FDE based system as in NR. However, requiring also the SSS to use the same sparse synchronization raster as center frequency may have drawbacks. For example, if a wideband SSS is used, the carrier center frequency may be too constrained. Furthermore, if SSS/PBCH is transmitted separately from the PSS, e.g., in an SSS/PBCH burst, transmitting the wideband SSS and PBCH on the same center frequency as other channels, e.g., common PDCCH, may limit the amount of center frequency switching.

In some cases, such as standalone access, a UE may search for synchronization signals, etc., based on procedures and parameters defined in a specification. For example, the UE may search for PSS on a predefined synchronization raster. Furthermore, the UE may perform blind detection of various parameters, such as PSS, SSS, and/or PBCH parameters based on candidate values defined in a specification, for instance using various candidate values as hypotheses during signal detection/decoding.

The radio resource overhead of a narrowband synchronization signal is significantly higher in SC-FDE systems, since a narrowband synchronization signal prevents transmission of other signals over the whole bandwidth for the duration of the synchronization signal transmission. In contrast, in OFDM-based systems, other transmissions can be frequency multiplexed during narrowband synchronization signal transmission, thereby reducing the effective overhead of the OFDM-based synchronization signals.

In an example numerical comparison not included here, it is assumed there is a similar PSS bandwidth and PSS duration for an SC-FDE based system as an OFDM-based system (as in 5G NR). The example analysis indicates that PSS/SSS/PBCH overhead for SC-FDE in the order of 12× more than that of the NR CP-OFDM system (e.g., 16.5% system overhead for SC-FDE vs 1.3% for CP-OFDM).

Furthermore, the long duration of a PSS/SSS/PBCH burst means that a UE needs to perform PSS detection during a longer time window, resulting in higher UE power consumption, etc. Therefore, there is a need for a flexible SC-FDE synchronization signal bandwidth design that achieves higher spectrum utilization and reduces overhead.

In NR, PSS, SSS and PBCH are transmitted together in an SSB with the same numerology. For the SC-FDE system, consider instead a narrowband PSS (with low symbol rate) and wideband SSS/PBCH (with high symbol rate), as illustrated in the example of FIG. 9. More specifically, the example of FIG. 9 illustrates separate PSS transmission in a PSS burst and SSS/PBCH transmission in an SSS/burst (or SSS/PBCH burst). Such a design would allow the UE to consume less power for narrowband PSS based cell search due to lower sampling rate during the PSS detection during the PSS period and on multiple points on the synchronization raster and enjoy less noise due to lower receiver bandwidth. Due to wideband SSS/PBCH transmission, the SSS/PBCH overhead could be significantly reduced. The wideband SSS/PBCH would also allow for higher synchronization and measurement accuracy for SSS-based measurement.

It may be beneficial to keep the PSS synchronization raster sparse, in order to reduce the UE effort. However, it may also be beneficial to transmit PSS/SSS/PBCH on the carrier center frequency, in order to avoid frequency switching. A compromise may be to transmit the PSS on the sparse synchronization raster while transmitting the SSS/PBCH on the carrier center frequency, e.g., on a channel raster. By separating the PSS and SSS/PBCH into a PSS burst and an SSS burst, as in FIG. 9, both the amount of symbol rate switching as well as the amount of center frequency switching can be reduced, compared to if the SC-FDE PSS/SSS/PBCH are transmitted together in an “SC-FDE SSB” as in NR.

To support different SC-FDE carrier bandwidths, different SSS/PBCH symbol rate may be supported. The UE may detect the SSS/PBCH symbol rate from a set of candidate SSS/PBCH symbol rates.

As introduced above, network power consumption is an important performance indicator in future wireless systems. One aspect of network power consumption is the minimum network power consumption level that can be achieved during low-traffic hours, e.g., during nighttime when there are no connected UEs in the cell. Future communication systems on higher frequencies may offer a smaller coverage range from a TRP, compared to a TRP in for example sub-GHz frequencies, which may imply fewer UEs per TRP on average. Hence, the minimum network power consumption level (at no traffic) may contribute to a large part of the overall network power consumption in future systems.

One way to reduce the minimum network power consumption is to turn off the TRP(s). While this results in very low, potentially zero, power consumption, it prohibits access to the network. Instead, some example embodiments described herein can minimize network power consumption while still allowing idle UEs to access the network, if needed.

In cell dormancy herein, all DL signals/channels but PSS may be turned off, such as in a cell or in multiple cells in an area. The transmission of PSS, but not SSS/PBCH, in a legacy system, means that a UE cannot access the network/cell. Furthermore, with SSS absent in a legacy system, a UE cannot even detect cells, as SSS detection is part of cell detection. For brevity, the term cell and cell dormancy may be used as an example below, but cell may also correspond to network(s), carrier(s), TRP(s), etc., and cell dormancy may correspond to network dormancy, carrier dormancy, TRP dormancy, etc. Cell dormancy may in some cases be called network energy savings.

Certain example embodiments provided herein enable standalone access to a dormant cell, for example, by the introduction of dormant cell detection and transmission of cell activation request.

Some example embodiments may include or be directed to a process for determination of dormancy or non-dormancy of a cell. According to an embodiment, a UE that performs PSS detection on one or more synchronization frequencies may detect one or more PSS peaks corresponding to different time offsets, frequency offsets (e.g., Doppler shift), e.g., in relation to a synchronization frequency, and/or PSS sequences. The UE may discard PSS peaks with an amplitude or power below a threshold, which may be predefined, configured, etc. The UE may determine whether the cell is dormant, for example, based on the PSS sequence, the PSS periodicity, and/or SSS absence, etc.

In an embodiment, dormancy may be detected based on PSS sequence. In this embodiment, the set of possible PSS sequences may be divided into two disjoint subsets. If the UE detects a PSS sequence from the first subset, for instance called the dormant PSS sequence subset, the UE may determine that the cell(s) that transmitted the PSS is dormant. If the UE detects a PSS sequence from the second subset, for instance called the non-dormant PSS sequence subset, the UE may determine that the cell(s) that transmitted the PSS is not dormant. The determination of dormancy or non-dormancy may be applicable to the synchronization frequency of the detected PSS, or a set of synchronization frequencies associated with the synchronization frequency of the detected PSS.

For example, the dormant PSS sequence subset may comprise a single PSS sequence, while the non-dormant PSS sequence subset may comprise all other PSS sequences.

According to an embodiment, a UE that detected a PSS from the non-dormant PSS sequence subset may proceed to receive SSS/PBCH and access the cell accordingly.

In some cases, the PSS sequence(s) used in case of dormancy may be different in other aspects than just the sequence itself. For example, the sequence length, type, and/or CP may be different. In some cases, the PSS sequence is repeated in case of dormancy. In an example, the PSS sequence may be consecutively repeated, e.g., so that a dormancy PSS sequence may comprise multiple consecutive non-dormancy PSS sequences. In another example, the PSS sequence may be non-consecutively repeated. For instance, in case of dormancy, an additional PSS may be transmitted at the time an associated SSS and/or PBCH would be transmitted in case of non-dormancy, e.g., instead of the SSS and/or PBCH. The PSS sequence(s) used in case of dormancy may in some cases be classified as a different kind of synchronization signal, for example a Dormancy Synchronization Signal (DSS). For simplicity, such cases may be included in the notion of dormancy detection based on PSS sequence.

In an embodiment, dormancy may be detected based on PSS periodicity. The set of possible PSS periodicities may be divided into two disjoint subsets. If the UE detects a PSS with a periodicity from the first subset, for instance called the dormant PSS periodicity subset, the UE may determine that the cell(s) that transmitted the PSS is dormant. If the UE detects a PSS with a periodicity from the second subset, for instance called the non-dormant PSS periodicity subset, the UE may determine that the cell(s) that transmitted the PSS is not dormant.

For example, the dormant PSS periodicity subset may comprise a single PSS periodicity, while the non-dormant PSS periodicity subset may comprise all other PSS periodicities. For instance, the PSS periodicity in the dormant PSS periodicity subset may be longer than the periodicities in the non-dormant PSS periodicity subset.

According to an embodiment, a UE that detected a PSS with a periodicity from the non-dormant PSS periodicity subset may proceed to receive SSS/PBCH and access the cell accordingly.

In an embodiment, dormancy may be detected based on SSS absence. A UE that detected a PSS peak may attempt detection/decoding of an SSS(s) and/or PBCH(s) that is associated with the detected PSS. For example, a time-domain location of an associated SSS may be a certain time delay after the detected PSS. If the UE doesn't detect/decode an associated SSS and/or PBCH, the UE may determine that the cell(s) that transmitted the PSS is dormant. If the UE detects an associated SSS, the UE may determine that the cell(s) that transmitted the PSS is not dormant.

As also discussed above, an associated SSS and/or PBCH may be replaced by a repetition of the detected PSS, for example, at the nominal starting time of the SSS and/or PBCH.

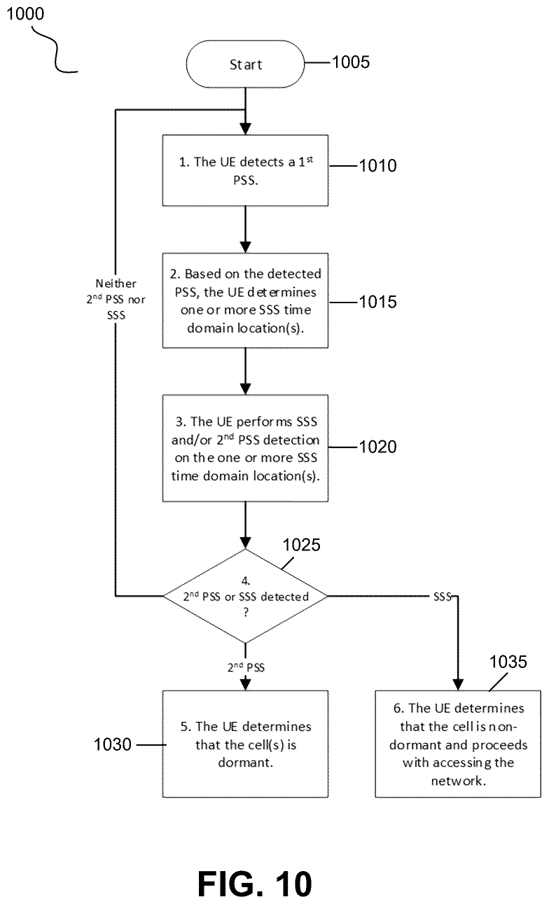

FIG. 10 illustrates a method 1000, which may be implemented by a UE, for determining network dormancy, according to one example embodiment. In the example of FIG. 10, after detection of a 1^{st} PSS, the UE may determine dormancy/non-dormancy based on whether a 2^{nd} PSS or an SSS is detected on an SSS time location. More specifically, the method may start at 1005 and, at 1010, the UE may detect a 1^{st} PSS. At 1015, based on the detected PSS, the UE may determine one or more SSS time domain location(s). At 1020, the UE may perform SSS and/or 2^{nd} PSS detection on the one or more SSS time domain location(s). At 1025, the UE may determine whether 2^{nd} PSS or SSS detected. If neither a 2^{nd} PSS nor a SSS are detected, then the method 1000 may return to the start 1005. If a 2^{nd} PSS is detected, then at 1030, the UE may determine that the cell(s) is/are dormant. If SSS is detected, then at 1035, the UE may determine that the cell is non-dormant and may proceed with accessing the network.

Some example embodiments may include or be directed to UE determination to transmit a cell activation request (CAR). In an embodiment, if the UE has determined that a cell is in a cell dormancy state, the UE may determine to transmit a cell activation requestion (CAR). The determination to transmit the CAR may be based on one or more criteria, in addition to the determination of cell dormancy. Example criteria are discussed below.

The UE may determine a received power of a detected PSS, for example, based on one or more corresponding PSS correlation peaks. A criterion for transmitting a CAR may be that the received power of a PSS corresponding to dormancy is above a threshold.

In some cases, a UE may detect both PSS(s) corresponding to dormancy and PSS(s) corresponding to non-dormancy. The UE may determine a received power corresponding to non-dormancy PSS. The received power may correspond to PSS received power and/or SSS received power, where the SSS is associated with a non-dormant PSS. For example, the UE may determine the maximum received power among the PSS(s)/SSS(s) corresponding to non-dormancy. A criterion for transmitting a CAR may be that the non-dormancy received power, e.g., the maximum non-dormancy received power, is below a threshold.

It may be worthwhile to activate a dormant cell if the corresponding received power is significantly higher than that of a non-dormant cell. Hence, a UE may determine a difference between a dormancy PSS received power (e.g., as described above) and a non-dormancy PSS received power (e.g., as described above). A criterion for transmitting a CAR may thus be that the difference is above a threshold.

As described above, 5G NR includes cell categories such as acceptable cells and suitable cells. A UE may preferably camp on a suitable cell but may also camp on an acceptable cell. However, if a UE determines that no suitable cell is available and also determines cell dormancy, it may be beneficial if the UE requests cell activation, so that hopefully an activated cell is suitable.

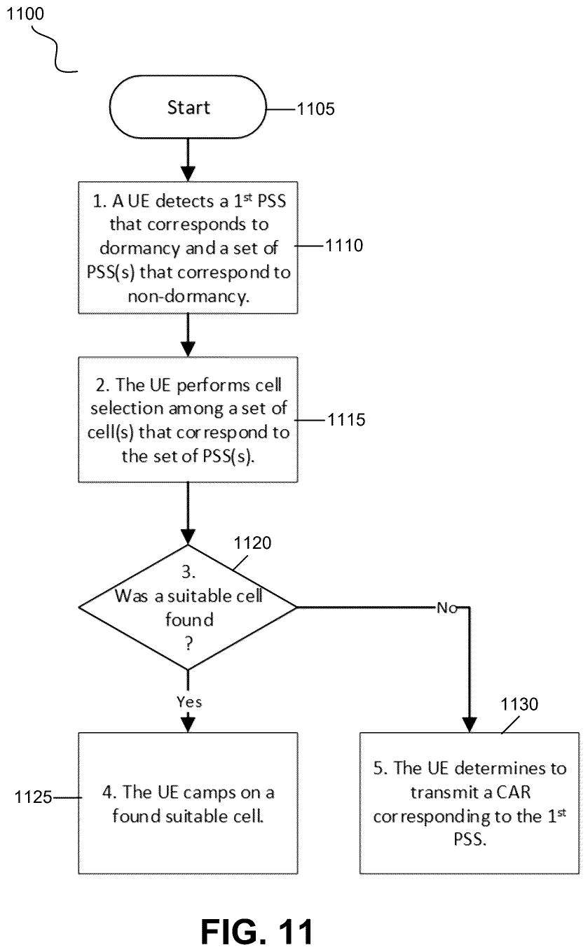

FIG. 11 illustrates an example method 1100, which may be implemented by a UE, for determining to transmit a CAR based on the availability of a suitable cell, according to an example embodiment. The method 1100 may start at 1105 and, at 1110, the UE may detect at least one PSS (e.g., 1^{st} PSS) that corresponds to dormancy, as described above. The UE may also detects a set of at least one PSS that correspond to non-dormancy. At 1115, the UE may perform cell selection among a set of at least one cells that correspond to the set of PSS(s). Note that different PSSs in the set of PSSs may correspond to the same cell, for example if a cell transmits multiple time-division multiplexed PSS, or may correspond to different cells. It is also possible that a PSS in the set of PSS(s) corresponds to multiple different cells, for example if multiple cells simultaneously transmit the same PSS but different SSS/PBCH. At 1120, the UE determines if a suitable cell was found. If it determines that a suitable cell is found, the UE camps on a found suitable cell at 1125. If it determines that suitable cell is not found, the UE proceeds to 1130 and determines to transmit a CAR corresponding to the 1^{st} PSS.

Note that the UE may have detected a set of multiple PSSs that correspond to dormancy in step 1110. If so, the UE may determine to transmit a CAR for a subset of the set of detected PSSs in step 1130. The UE may determine the subset of PSS(s) for instance as the M strongest PSS(s), PSSs on different synchronization frequencies, and/or PSS(s) corresponding to a positive frequency offset, etc.

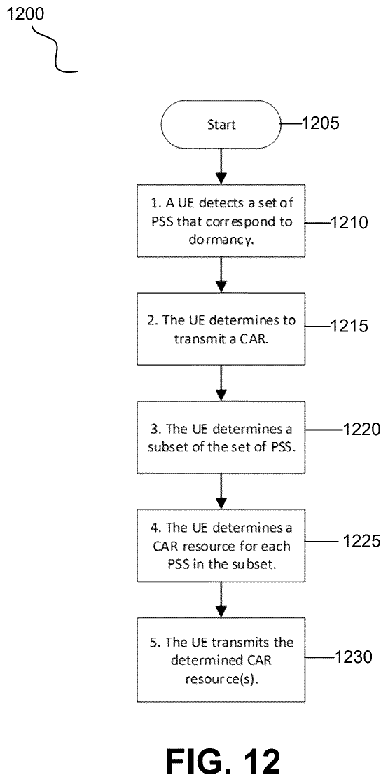

Some example embodiments may include or may be directed to a UE procedure for transmission of cell activation request (CAR). FIG. 12 illustrates an example method 1200, which may be implemented by a UE, for transmission of CAR, according to an example embodiment. The method 1200 may start at 1205 and, at 1210, the UE may detect a set of PSS that correspond to dormancy (e.g., detect set of PSS that are associated with a dormant cell). At 1215, the UE may determine to transmit a CAR. At 1220, the UE determines a subset of the set of detected PSS for which to transmit CAR. For example, the UE may determine a detected PSS for which to transmit a CAR. At 1225, the UE determines CAR resource(s) for the subset of detected PSS, e.g., a detected PSS. At 1230, the UE may transmit CAR(s) on the determined CAR resource(s).

Some example embodiments may include or may be directed to UE determination of resource(s) for cell activation request (CAR). For example, if the UE has detected dormancy and determined to transmit a cell activation request, e.g., as described above or illustrated in the examples of FIGS. 10-12, the UE may determine resource(s) for cell activation request (CAR) transmission.

A time-frequency resource for a CAR (a CAR resource) may comprise M time-frequency resources (M≥1), e.g., PRACH occasions, which may be contiguous or non-contiguous. PRACH and PRACH occasions (PO) may be used below as an example, but another UL channel/signal may be utilized instead. A CAR resource may be periodic. The CAR resource periodicity may be predefined, e.g., in a specification. The CAR resource periodicity may be based on the PSS numerology, e.g., the PSS symbol rate. The CAR resource periodicity may be based on the PSS periodicity. The CAR resource periodicity may be N or 1/N times the PSS periodicity, where N is a positive integer. For example, if N=1, the CAR resource periodicity is equal to the PSS periodicity.

The CAR resource center frequency may be based on the center frequency of the PSS, e.g., the center frequency of the PSS plus a frequency offset, which may be predefined or determined based on the frequency band, synchronization frequency (e.g., synchronization raster point), and/or PSS symbol rate, etc. In one example, the frequency offset is zero, which means that the CAR center frequency and the PSS center frequency is the same.

A CAR resource may start a time offset after a PSS, wherein the time offset may be predefined, based on the frequency band, and/or, based on the PSS symbol rate, etc. In one example, a CAR resource may start an integer number of symbols after the start of a detected PSS, where the symbol duration may be based on the PSS symbol rate. The starting time of the CAR resource may be advanced by a timing advance (TA) value, which may depend on the synchronization frequency, frequency band, and/or the PSS and/or CAR symbol rate/duration.

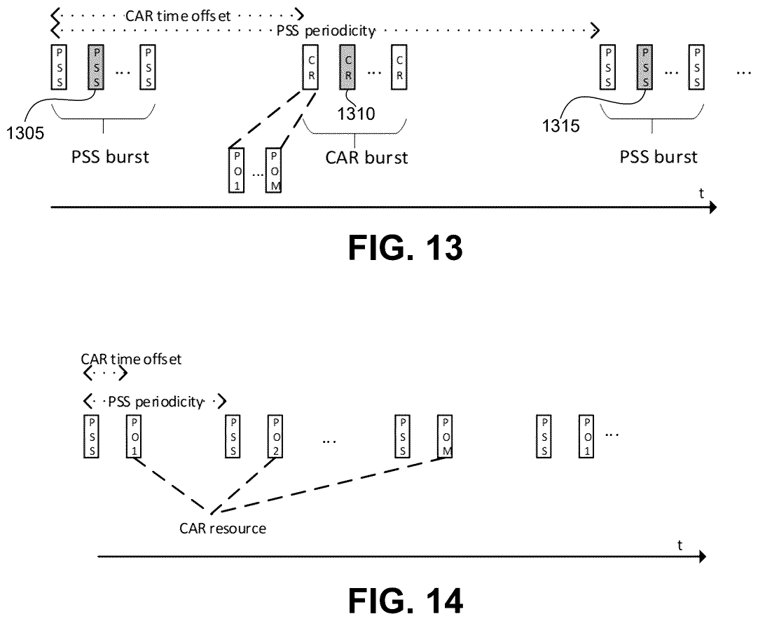

FIG. 13 illustrates an example of a CAR resource (CR) that includes M PRACH occasions (PO). The example of FIG. 13 shows a burst of CAR resources (CAR burst), wherein a CAR resource (CR) occurs a CAR time offset after a corresponding PSS. A CAR resource may comprise one or more PRACH occasions (M PRACH occasions in this example). The grey shaded PSS 1305, 1315 may correspond to a PSS detected by the UE and the grey shaded CR 1310 may correspond to the CR determined by the UE, based on the detected PSS and the CAR time offset.

If the CAR resource periodicity is N times the PSS periodicity, where N>1, the UE might not know after which PSS occasion the CAR resource occurs. In this case, the UE may transmit a CAR multiple times, e.g., M times, with for instance M=N. Alternatively, e.g., with a CAR periodicity equal to the PSS periodicity, the UE may determine M consecutive CAR resources for CAR transmission. In a similar example illustrated in FIG. 14, a CAR resource may comprise M PRACH occasions that for instance may occur after M (e.g., consecutive) PSS occasions, wherein each of the PRACH occasions occurs a time offset after a corresponding detected PSS. The UE may transmit CAR in M consecutive PRACH occasions. If the UE would transmit in M consecutive PRACH occasions, the network may choose to only perform CAR/PRACH detection in every Mth PRACH occasion, thereby potentially saving power. Note that the network may need to perform the CAR/PRACH reception and detection constantly during dormancy in order to potentially detect a CAR, while the UE may need to transmit the CAR only once. Hence, increasing the amount of UE transmissions by M (only once) may be worthwhile if the amount of network detection can be reduced by M (all the time during dormancy).

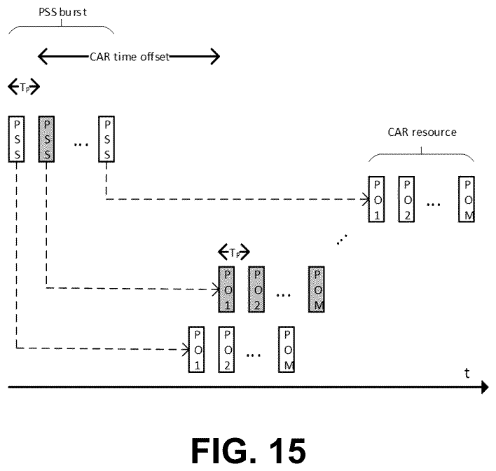

A CAR resource may comprise M POs with consecutive POs being separated in time by T_{P}, wherein T_{P} may correspond to a time separation between consecutive PSSs in a PSS burst or sub-burst (also further discussed below). FIG. 15 illustrates an example of a CAR resource (CR) comprising M PRACH occasions (PO) separated by a PSS-to-PSS separation. Since consecutive POs are separated by T_{P}, the second PO corresponding to a first PSS may overlap in time with a first PO corresponding to a second PSS. This overlap may reduce the PO detection burden on the network side since POs corresponding to multiple PSS overlap in time. At this stage, the network might not need to know exactly which PSS that the UE detected, but rather that one of M PSSs was detected.

In various examples with a CAR resource comprising M POs, the UE may transmit the PRACH on the M POs using a spatial filter determined based on reception of the associated PSS (PSS spatial filter). In other examples, the UE may transmit a subset of the M PRACH using the PSS spatial filter, e.g., the first PRACH (e.g., on PO1 as illustrated in FIG. 13, FIG. 14 and/or FIG. 15). For the transmission of the other PRACH, the UE may use other spatial filter(s), e.g., spatial filter(s) up to the UEs choice, spatial filter(s) based on the reception of other PSS(s) than the associated PSS. In one example, the UE detects multiple PSSs (corresponding to dormancy) and transmits PRACHs on the first POs corresponding to the detected multiple PSSs, using the PSS spatial filter corresponding to the detected PSS for which the PO is the first PO. For other POs, the choice of spatial filter may be up the UE implementation.

In some cases, a UE may detect multiple PSSs corresponding to dormancy, wherein the multiple PSS might not be separated by the PSS period. The multiple detected PSS may correspond to different TRPs, beams, propagation paths, etc. The UE may determine one or more CAR resource(s) for one or more of the multiple detected PSS. The UE may select a PSS from the multiple detected PSS for which to transmit a CAR, e.g., the strongest PSS. In some cases, the UE may determine multiple CAR resources corresponding to the multiple detected PSSs.

The time-frequency resources of a PRACH occasion in a CAR resource may follow the time-frequency resources of a predefined PRACH format, where the PRACH format may be one of the PRACH formats supported for a random access procedure.

The UE may determine a numerology for a CAR or corresponding PRACH, e.g., a symbol rate, CP, subcarrier spacing, etc. The CAR time-frequency resource size may depend on the CAR numerology, e.g., duration and bandwidth. The UE may determine the CAR numerology based on the numerology of the detected PSS, and/or the synchronization frequency/band. For example, a one-to-one mapping between PSS symbol rates and CAR symbol rates may be defined, e.g., in a specification. The UE may determine the CAR symbol rate based on the symbol rate of the detected PSS.

A set of multiple PRACH preambles may be defined. In some cases, a single PRACH preamble (preamble index) from the set may be used for CAR. In some cases, a subset of the PRACH preambles from the set may be used for CAR. In some cases, the UE randomly selects a preamble from the subset. In other cases, the UE may determine a preamble from the subset based one or more criteria, as discussed below.

In one example, the UE determines a PRACH preamble based on its capabilities, e.g., which version of a communication standard it supports, or which feature(s) or feature group(s) it supports. The UE capability may be in the form of a UE category (incl. DL category and/or UL category) or a UE class (incl. DL class and/or UL class), e.g., power class. The network may adjust its subsequent activation/operation based on the indicated UE capability.

In another example, the UE determines a PRACH preamble based on its state (or mode), e.g., based on if the UE is in idle, inactive, connected, or other state. A UE state may be associated with a subset of preamble indices (e.g., a single index). Based on its state, the UE may first determine a subset, and secondly determine a preamble index within the subset. If the subset comprises a single index, the UE may directly determine a preamble index based on its state. In some cases, UE states are 1-to-1 associated with different subsets which may be disjoint or partly/fully overlapping. In some cases, multiple UE states are associated with the same subset.

In yet another example, the UE determines a PRACH preamble based on its service or QOS characteristics/requirements. Example characteristics/requirements may include, for instance, DL/UL data rate, latency, and/or reliability.

Some example embodiments may include or may be directed to UE transmission of cell activation request (CAR). For example, upon or based on determining one or more CAR resources, the UE may transmit CAR on the one or more CAR resources, e.g., M CAR resources. Transmission of a CAR may comprise transmission of one or more PRACH, e.g., M PRACH. The UE may use the same spatial domain filter for transmitting a CAR as it used for receiving a corresponding PSS, e.g., the PSS that preceded the CAR resource by the time offset.

In some cases, e.g., if a CAR resource comprises multiple PRACH occasions, the UE may transmit the CAR resource using multiple spatial domain filters, e.g., different spatial domain filters for different PRACH occasions. Similarly, for example, if a UE transmits CAR on one or more CAR resources, the UE may transmit CAR on different CAR resources using different spatial domain filters.

In some cases, the UE may detect a change from dormancy to non-dormancy prior to the transmission of the M CARs or M PRACH. If so, the UE may terminate the CAR/PRACH transmission after transmission of less than M CARs/PRACH.

In some cases, the determined one or multiple CAR resources overlap in time, e.g., the CAR resources corresponding to multiple PSSs that are received closely in time. If so, the UE may choose to omit the transmission on one or more of these CAR resources so that the remaining CAR resources for transmission are non-overlapping, based on a CAR resource selection which may be based on received power on the corresponding PSS. In some cases, the UE may transmit partial CAR in case of overlapping CAR resources, e.g., by transmitting a partial CAR for CAR resource(s) corresponding to lower received PSS power than the overlapping CAR resource(s).

The UE may apply a timing advance (TA) to the CAR transmission. The UE may determine the TA value based on the PSS numerology, e.g., PSS symbol rate, and/or the frequency (or frequency band) of the detected PSS.

Some example embodiments may include or may be directed to a UE procedure for access upon cell activation request (CAR) transmission. For example, upon or after CAR transmission, the UE may attempt to detect a change from cell dormancy to non-dormancy. The detection of such a change may depend on how dormancy may be detected, as discussed above.

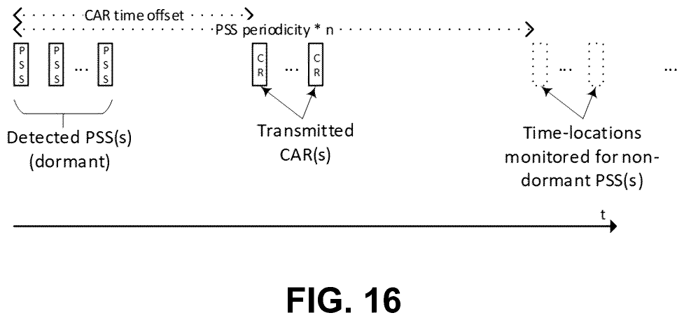

For example, if dormancy may be detected based on PSS sequence, the UE may detect a change from dormancy to non-dormancy through detection of a PSS sequence from the non-dormant PSS sequence subset. Upon or after CAR transmission, the UE may expect that PSS with non-dormant PSS sequence may be received at or around the time location(s) of a detected PSS(s) with a dormant PSS sequence. Time location(s) of a detected PSS with a periodicity T may correspond to time instance n*T after the detected PSS, wherein n may be a positive integer. FIG. 16 illustrates an example of time locations for monitoring of non-dormant PSS corresponding to transmitted CAR(s). In some cases, and as illustrated in the example of FIG. 16, the UE may expect a non-dormant PSS sequence to be transmitted at or around the one or more of the time location(s) of the detected PSS(s) (with dormant PSS sequence(s)) for which the UE transmitted CAR(s).

In another example, if dormancy may be detected based on PSS periodicity, the UE may detect a change from dormancy to non-dormancy through detection of a PSS periodicity from the non-dormant PSS periodicity subset. If a non-dormant PSS periodicity is an integer fraction of the detected dormant PSS periodicity, the UE may upon (or after) CAR transmission expect that PSS with the non-dormant PSS periodicity may be received at or around at least the time location(s) of a detected PSS(s) with a dormant PSS periodicity. In some cases, the UE may upon CAR transmission expect that PSS with the non-dormant PSS periodicity may be received at or around at least the time location(s) of a detected PSS(s) (with a dormant PSS periodicity) for which the UE transmitted CAR(s).

In yet another example, if dormancy may be detected based on SSS presence, the UE may detect a change from dormancy to non-dormancy through detection of SSS. The UE may perform SSS and/or PBCH detection for SSS/PBCH associated with detected PSS(s). In some cases, the UE may perform SSS and/or PBCH detection for SSS/PBCH associated with detected PSS(s) for which the UE transmitted CAR(s).

When switching from dormancy to non-dormancy, the cell may change PSS transmission timing, for example, if the PSS burst time domain structure is different in dormant and non-dormant state. Hence, upon CAR transmission, the UE may perform cell search again, including PSS search, to detect potential new PSS timing. A UE may determine a change from dormancy to non-dormancy by determining that a PSS corresponding to dormancy disappeared. Additionally, a UE may determine a change from dormancy to non-dormancy by determining that a PSS corresponding to non-dormancy appeared, e.g., with a PSS timing, received power, sequence and/or similar that may be associated with (e.g., same as or similar) a previously detected dormant PSS for which the transmitted a CAR.

In some cases, the UE may assume that a cell that switches from dormancy to non-dormancy retains some PSS parameter values, such as, PSS symbol rate, PSS timing, etc. This may imply that the UE can avoid PSS detection of a non-dormancy PSS based on a set of candidate PSS parameter values, upon CAR transmission.

If the UE does not detect a change from dormancy to non-dormancy, the UE may transmit CAR(s) again. The UE may retransmit the same set of CAR(s) as for the previous transmission of CAR(s), e.g., on CAR resource(s) corresponding to the previously detected PSS(s). In some cases, the UE may perform PSS detection again, and determine new CAR resource(s) based on newly detected PSS(s) and transmit CAR(s) on the newly determined CAR resource(s).

Upon detection of non-dormancy, the UE may proceed with SSS/PBCH reception, for example, as described below.

The UE may estimate a pathloss based on the detected PSS, for example, based on a PSS transmit power and a measured PSS received power. The UE may determine a PSS transmit power. For example, the UE may determine a PSS transmit power based on a specification in which a transmit power depending on the synchronization frequency may be specified.

The UE may determine an initial CAR transmit power based on the estimated pathloss and a target received power for the initial CAR(s) transmission, e.g., as the sum (in dB) of the target received power and the pathloss.

If the UE determines to transmit CAR(s) again, e.g., if the UE didn't detect a change from dormancy to non-dormancy, the UE may either maintain or increase the CAR transmit power. For example, the UE may increase the CAR transmit power by a certain offset, in addition to any transmit power adjustment based on an updated pathloss estimate. The UE may accumulate multiple power offsets across multiple CAR re-transmissions. The UE may need to limit the CAR transmit power to a certain pre-defined maximum power level, or by a maximum UE transmit power.

As described herein, a UE may detect, measure, and/or synchronize to synchronization signal(s) (e.g., PSS and/or SSS), and/or receive and successfully decode PBCH. The UE may monitor PDCCH, e.g., based on a decoded PBCH, and subsequently receive a PDSCH scheduled by a received PDCCH, e.g., for reception of system information, paging, random access response, random access message 4, etc. The UE may transmit one or more PRACH, based on the time- and/or frequency synchronization (e.g., incl. DL frame timing) determined from the received synchronization signal(s), on time- and/or frequency resources determined from a specification and/or a configuration obtained in a received system information message. The UE may also transmit a PUSCH, e.g., scheduled by a received PDCCH, e.g., a random access message 3, random access message A, etc.

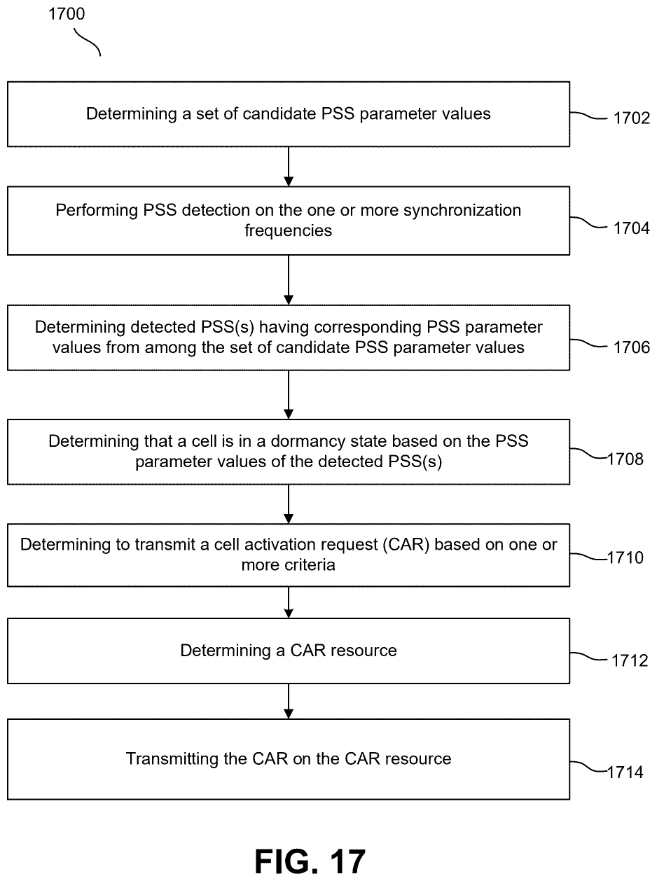

FIG. 17 illustrates an example flow diagram of a method 1700, which may be implemented in a wireless transmit/receive unit (WTRU). For example, in some embodiments, the method may include any one or more of the steps performed by or associated with a UE as discussed elsewhere herein. For example, in certain embodiments, one or more of the steps of the method 1700 may correspond to, may relate to, or may include those described in or illustrated with respect to FIGS. 10, 11 and/or 12. It should also be understood that one or more of the steps of the method may be optional, may be omitted, and/or may be performed in a different order.

In an embodiment, as illustrated in the example of FIG. 17, the method 1700 may include, at 1702, determining a set of candidate PSS parameter values. As an example, the candidate PSS parameter values may include any one or more of candidate PSS sequences, candidate PSS symbol rate, PSS periodicity, etc.

According to an embodiment, the method 1700 may include, at 1704, performing PSS detection on the one or more synchronization frequencies, based on the set of candidate PSS parameter values (e.g., as discussed above with respect to FIG. 10). In one embodiment, the UE may determine the one or more synchronization frequencies or they may be otherwise provided or determined.

In an embodiment, the method 1700 may include, at 1706, determining, e.g., based on the PSS detection, one or more (or a set of) detected PSS (e.g., at least one PSS) having corresponding PSS parameter values from among the set of candidate PSS parameter values. The method 1700 may include, at 1708, determining that a cell is in a dormancy state (or is dormant), e.g., based on the PSS parameter values of the detected PSS. For example, in some embodiments, the determining at 1708 may include determining that a subset of the set of detected PSS correspond to dormancy or dormancy PSS (e.g., as discussed above with respect to FIG. 10). In some examples, another subset of the set of PSS may correspond to non-dormancy, e.g., the PSS that are not determined to correspond to dormancy. In an embodiment, the determining at 1708 may include determining that a detected PSS corresponds to dormancy (or non-dormancy) based on the PSS parameter values of the detected PSS, e.g., the PSS sequence (or other PSS parameter values, such as PSS symbol rate, periodicity, etc.).

According to an embodiment, the method 1700 may include, at 1710, determining to transmit a cell activation request based on one or more criteria associated with the detected PSS (e.g., determining to transmit cell activation request corresponding to a dormancy PSS). For instance, the one or more criteria may include any one or more of: (i) a received power of a PSS corresponding to dormancy is above a threshold, (ii) a maximum received power among the PSS(s) corresponding to non-dormancy is below a threshold, (iii) a difference between the received power of a PSS corresponding to dormancy and the maximum received power among the PSS(s) corresponding to non-dormancy is above a threshold, and (iv) one or more (e.g., all) non-dormant cell(s) (with non-dormant PSS) are not suitable, for example, they are barred or have received power or quality below a threshold. As an example, the determining at 1710 may include determining to transmit a cell activation request if the non-dormancy PSS correspond to cells that are not suitable (to camp on).

In an embodiment, the method 1700 may include, at 1712, determining a cell activation request (CAR) resource based on or for the detected PSS (e.g., dormancy PSS). For example, in an embodiment, the determining at 1712 may include determining one or more PRACH occasions with one or more time offsets from the detected PSS (e.g., dormancy PSS). In an embodiment, the one or more time offsets may be determined based on the candidate primary synchronization signal (PSS) parameter values. In other words, in certain example embodiments, the cell activation request (CAR) resource is a certain time offset after the detected at least one primary synchronization signal (PSS), and the certain time offset is determined based on the candidate primary synchronization signal (PSS) parameter values.

According to an embodiment, the method 1700 may include, at 1714, transmitting the cell activation request (CAR) on the cell activation request (CAR) resource.

In some example embodiments, the method 1700 might further include performing PSS detection on the synchronization frequency of the dormancy PSS for which the cell activation request was transmitted. According to an embodiment, the method 1700 may include determining a set of detected PSS with corresponding PSS parameter values, based on the PSS detection, selecting a detected PSS for SSS detection (e.g., a PSS corresponding to non-dormancy), and performing SSS detection. In an embodiment, the method 1700 may include detecting an SSS based on the SSS detection and determining a PBCH resource based on the detected SSS. Based on the detected PSS, SSS, and decoded PBCH, the method 1700 may include determining resource(s) for PDCCH monitoring, monitoring the PDCCH resources, receiving and/or successfully decoding a PDCCH on a PDCCH resource. Based the decoded PDCCH, the method 1700 may include receiving system information, and accessing the cell, based on the system information, e.g., by performing random access.

In view of the above, some example embodiments may include a method that may be implemented by a WTRU. The method may include determining a set of candidate PSS parameter values and performing, based on the set of candidate PSS parameter values, PSS detection on one or more synchronization frequencies. In other words, the WTRU may detect PSSs on one or more synchronization frequencies. Then, based on detecting one or more PSSs, the method may include determining at least one PSS (from among the detected PSSs) that has (e.g., is associated with) corresponding PSS parameter values from the set of candidate PSS parameter values. In other words, the WTRU determines at least one PSS that has associated parameter values (e.g., sequence ID, etc.) that is within (e.g., included in) the set of candidate PSS parameter values.

In certain embodiments, based on the PSS parameter values of one or more of the at least one determined PSS, the method may include determining that a cell is in a dormancy state. It is noted that some of the at least one determined PSS could have parameter values within the set of candidate PSS parameter values that correspond to cell dormancy, while other ones of the at least one determined PSS could have parameter values within the set of candidate parameter values that correspond to non-dormancy of the cell.

In an embodiment, the method may then include determining a cell activation request (CAR) resource, e.g., based on the one or more of the at least one determined PSS. For instance, in one example, the CAR resource may be determined based on the received timing of the one or more of the at least one determined PSS. The method may include transmitting, based on one or more criteria associated with the one or more of the at least one determined PSS, the cell activation request (CAR) on the determined CAR resource.

In an embodiment, the candidate PSS parameter values comprise any of: PSS sequence index, PSS sequence initialization value, PSS sequence length, PSS repetition factor, PSS periodicity, and/or PSS symbol rate.

In an embodiment, a first subset of the set of candidate PSS parameter values correspond to the dormancy state. In an embodiment, the method may include determining that the cell is in the dormancy state on condition that any of the PSS parameter values of the at least one PSS belongs to the first subset of the candidate PSS parameter values that correspond to the dormancy state.

In an embodiment, the method may include, based on the PSS parameter values of another one or more of the at least one PSS, determining that a cell is in a non-dormancy state. In an embodiment, a second subset of the set of candidate PSS parameter values correspond to the non-dormancy state.

In an embodiment, the method may include determining that the cell is in the non-dormancy state on condition that any of the PSS parameter values of the another one or more of the at least one PSS belongs to the second subset of the candidate PSS parameter values that correspond to the non-dormancy state.

In some examples, the criteria associated with the one or more of the at least one determined PSS may be based on PSS-based measurements of PSS(s) corresponding to cell dormancy and/or other PSS(s) (e.g., corresponding to cell non-dormancy.

For example, according to some embodiments, the one or more criteria associated with the at least one PSS comprise any of: (i) a received power of a PSS having PSS parameter values corresponding to the dormancy state is above a threshold, (ii) a maximum received power among PSSs having PSS parameter values corresponding to a non-dormancy state is below a threshold, (iii) a difference between a received power of a PSS having PSS parameter values corresponding to the dormancy state and a maximum received power among PSSs having PSS parameter values corresponding to a non-dormancy state is above a threshold, and/or (iv) one or more cells in a non-dormancy state are not suitable.

In an embodiment, the determining of the cell activation request (CAR) resource comprises determining one or more physical random access channel (PRACH) occasions with one or more time offsets from the at least one PSS.

In an embodiment, the cell activation request (CAR) resource comprises any of: a time-frequency resource that starts a determined time offset after the at least one PSS, multiple time-frequency resources that are separated in time by a periodicity of the at least one PSS, and/or multiple time-frequency resources that are separated in time by a determined intra-burst PSS separation.

It is noted that the flow diagrams illustrated in FIGS. 10-12 and 17 are provided as an example, and modifications thereto are contemplated according to certain embodiments. For example, one or more of the steps illustrated in FIGS. 10-12 and 17 may be omitted, may be combined and/or may be performed in a different order.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

What is claimed is:

1. A wireless transmit/receive unit (WTRU), comprising:
circuitry, including any of a processor, memory, transmitter and receiver, the circuitry configured to:
determine a set of candidate primary synchronization signal (PSS) parameter values;
perform, based on the set of candidate PSS parameter values, PSS detection on one or more synchronization frequencies;
based on detecting one or more PSS, determine at least one PSS having corresponding PSS parameter values from the set of candidate PSS parameter values;
based on the PSS parameter values of one or more of the at least one determined PSS, determine that a cell is in a dormancy state;
determine a cell activation request (CAR) resource based on the at least one determined PSS; and
transmit, based on one or more criteria associated with the at least one determined PSS, a cell activation request (CAR) on the cell activation request (CAR) resource.

2. The WTRU of claim 1, wherein the candidate PSS parameter values comprise any of: PSS sequence index, PSS sequence initialization value, PSS sequence length, PSS repetition factor, PSS periodicity, and PSS symbol rate.

3. The WTRU of claim 1, wherein a first subset of the set of candidate PSS parameter values correspond to the dormancy state.

4. The WTRU of claim 3, wherein the circuitry is configured to determine that the cell is in the dormancy state on condition that any of the PSS parameter values of the at least one PSS belongs to the first subset of the candidate PSS parameter values that correspond to the dormancy state.

5. The WTRU of claim 1, wherein the circuitry is configured, based on the PSS parameter values of another one or more of the at least one PSS, to determine that a cell is in a non-dormancy state.

6. The WTRU of claim 5, wherein a second subset of the set of candidate PSS parameter values correspond to the non-dormancy state.

7. The WTRU of claim 6, wherein the circuitry is configured to determine that the cell is in the non-dormancy state on condition that any of the PSS parameter values of the another one or more of the at least one PSS belongs to the second subset of the candidate PSS parameter values that correspond to the non-dormancy state.

8. The WTRU of claim 1, wherein the one or more criteria associated with the at least one PSS comprise any of: (i) a received power of a PSS having PSS parameter values corresponding to the dormancy state is above a threshold, (ii) a maximum received power among PSSs having PSS parameter values corresponding to a non-dormancy state is below a threshold, (iii) a difference between a received power of a PSS having PSS parameter values corresponding to the dormancy state and a maximum received power among PSSs having PSS parameter values corresponding to a non-dormancy state is above a threshold, and (iv) one or more cells in a non-dormancy state are not suitable.

9. The WTRU of claim 1, wherein, to determine the cell activation request (CAR) resource, the circuitry is configured to determine one or more physical random access channel (PRACH) occasions with one or more time offsets from the at least one PSS.

10. The WTRU of claim 1, wherein the cell activation request (CAR) resource comprises any of: a time-frequency resource that starts a determined time offset after the at least one PSS, multiple time-frequency resources that are separated in time by a periodicity of the at least one PSS, and multiple time-frequency resources that are separated in time by a determined intra-burst PSS separation.

11. A method, comprising:
determining a set of candidate primary synchronization signal (PSS) parameter values;
performing, based on the set of candidate PSS parameter values, PSS detection on one or more synchronization frequencies;
based on detecting one or more PSS, determining at least one PSS having corresponding PSS parameter values from the set of candidate PSS parameter values;
based on the PSS parameter values of one or more of the at least one determined PSS, determining that a cell is in a dormancy state;
determining a cell activation request (CAR) resource based on the at least one determined PSS; and
transmitting, based on one or more criteria associated with the at least one determined PSS, a cell activation request (CAR) on the cell activation request (CAR) resource.

12. The method of claim 11, wherein the candidate PSS parameter values comprise any of: PSS sequence index, PSS sequence initialization value, PSS sequence length, PSS repetition factor, PSS periodicity, and PSS symbol rate.

13. The method of claim 11, wherein a first subset of the set of candidate PSS parameter values correspond to the dormancy state.

14. The method of claim 13, comprising determining that the cell is in the dormancy state on condition that any of the PSS parameter values of the at least one PSS belongs to the first subset of the candidate PSS parameter values that correspond to the dormancy state.

15. The method of claim 11, comprising, based on the PSS parameter values of another one or more of the at least one PSS, determining that a cell is in a non-dormancy state.

16. The method of claim 15, wherein a second subset of the set of candidate PSS parameter values correspond to the non-dormancy state.

17. The method of claim 16, comprising determining that the cell is in the non-dormancy state on condition that any of the PSS parameter values of the another one or more of the at least one PSS belongs to the second subset of the candidate PSS parameter values that correspond to the non-dormancy state.

18. The method of claim 11, wherein the one or more criteria associated with the at least one PSS comprise any of: (i) a received power of a PSS having PSS parameter values corresponding to the dormancy state is above a threshold, (ii) a maximum received power among PSSs having PSS parameter values corresponding to a non-dormancy state is below a threshold, (iii) a difference between a received power of a PSS having PSS parameter values corresponding to the dormancy state and a maximum received power among PSSs having PSS parameter values corresponding to a non-dormancy state is above a threshold, and (iv) one or more cells in a non-dormancy state are not suitable.

19. The method of claim 11, wherein the determining of the cell activation request (CAR) resource comprises determining one or more physical random access channel (PRACH) occasions with one or more time offsets from the at least one PSS.

20. The method of claim 11, wherein the cell activation request (CAR) resource comprises any of: a time-frequency resource that starts a determined time offset after the at least one PSS, multiple time-frequency resources that are separated in time by a periodicity of the at least one PSS, and multiple time-frequency resources that are separated in time by a determined intra-burst PSS separation.
